(19) United States
(12) Patent Application Publication
(10) Pub. No.: US 2014/0047073 A1
(43) Pub. Date: Feb. 13, 2014

(54) Platform Independent Multimedia Playback Apparatuses, Methods, and Systems

(71) Applicant: Marcin Beme, Warsaw (PL)

(72) Inventor: Marcin Beme, Warsaw (PL)

(21) Appl. No.: 13/963,490

(22) Filed: Aug. 9, 2013

Related U.S. Application Data
(60) Provisional application No. 61/682,114, filed on Aug. 10, 2012.
(60) Provisional application No. 61/748,292, filed on Jan. 2, 2013.

(51) Int. Cl. H04L 29/06

(52) U.S. Cl. CPC H04L 65/601
USPC 709/219

(57) ABSTRACT

The PLATFORM INDEPENDENT MULTIMEDIA PLAYBACK APPARATUSES, METHODS, AND SYSTEMS (“PLAYPLAT”) may be configured to enable cross-device and cross-format synchronization of media content. The PLAYPLAT may conserve bandwidth through its selection of appropriate portions of media for synchronization, such as through the use of predictive technology. The PLAYPLAT can further be configured to scan media content and create meta-data suitable for cross-format synchronization. The PLAYPLAT may also enable consumer commerce transactions based on media consumption or other factors. Additionally, the PLAYPLAT may be configured to enable account creation without registration and conduct transactions anonymously.

### CROSS-REFERENCE TO RELATED APPLICATIONS

This application claims priority under 35 U.S.C. §119 to U.S. Provisional Patent Application No. 61/748,292, filed Jan. 2, 2013, and to U.S. Provisional Patent Application No. 61/682,114, filed Aug. 10, 2012. The content of each of these applications is expressly incorporated by reference herein in its entirety.

This application may contain material subject to copyright or other intellectual property protection. The respective owners of such intellectual property have no objection to the facsimile reproduction of the disclosure as it appears in documents published by the U.S. Patent and Trademark Office, but otherwise reserve all rights whatsoever.

### FIELD

The present innovations address multi-device/multi-location media playback, eBook reading, synchronization utilizing wired, mobile, cloud and/or the like infrastructure, account creation, transactions and more particularly, include PLATFORM INDEPENDENT MULTIMEDIA PLAYBACK APPARATUSES, METHODS, AND SYSTEMS (hereinafter, “PLAYPLAT”).

### BACKGROUND

Electronic media, including audio books, movies and eBooks are available in multiple formats. Consumers may consume electronic media using devices. Additionally, consumers may desire to engage in transactions. Consumers may be concerned with their privacy.

### SUMMARY

In one exemplary embodiment, the PLAYPLAT may include a processor-implemented method for synchronization of media in multiple formats across multiple devices. The method may include receiving, at a synchronization server, a changed context synchronization request from a first user device configured to allow a user to consume media in a first format; retrieving, using the synchronization server, a list of other devices accessible to a user associated with the first user device, wherein at least one of the devices is configured to allow the user to consume the media in at least a second format; sending, using the synchronization server, a sync point update request to at least one of the devices, wherein the sync point update request includes a sync point representing the last portion of the media consumed by the user; receiving, at the synchronization server, a sync point update response from at least one of the devices; generating, using the synchronization server, a changed context synchronization response based on the sync point update response received from at least one of the devices; and sending the changed context synchronization response to the first user device using the synchronization server.

In another exemplary embodiment, the PLAYPLAT may include a system for synchronization of media in multiple formats across multiple devices. The system may include a server having a processor and memory; a changed context module running on the server, the changed context module being configured to receive a changed context synchronization request from a first user device that allows a user to consume media in a first format; a device list module running on the server and configured to retrieve a list of other devices accessible to a user associated with the first user device, wherein at least one of the devices is configured to allow the user to consume the media in at least a second format; an update module running on the server and configured to send a sync point update request to at least one of the devices, wherein the sync point update request includes a sync point representing the last portion of the media consumed by the user; and receive a sync point update response from at least one of the devices. The changed context module may also be configured to generate a changed context synchronization response based on the sync point update response received from at least one of the devices and to send the changed context synchronization response to the first user device.

In another exemplary embodiment, the PLAYPLAT may include a processor-readable tangible medium for indexing and matching equivalent media files of different formats, the medium storing processor-issuable-and-generated instructions to: receive a changed context synchronization request from a first user device configured to allow a user to consume media in a first format; retrieve a list of other devices accessible to a user associated with the first user device, wherein at least one of the devices is configured to allow the user to consume the media in at least a second format; send a sync point update request to at least one of the devices, wherein the sync point update request includes a sync point representing the last portion of the media consumed by the user; receive a sync point update response from at least one of the devices; generate a changed context synchronization response based on the sync point update response received from at least one of the devices; and send the changed context synchronization response to the first user device using the synchronization server.

In another exemplary embodiment, the PLAYPLAT may include a system for indexing and matching equivalent media files of different formats. The system may include a regular expressions module configured to scan a text file and extract sentences and a sentence position indicator from each paragraph in the text file; a speech recognition module configured to search for the sentences in an audio file, with media content that is equivalent to the text file, for a portion of the audio file matching each sentence extracted by the regular expressions module; and create a timestamp associated with the portion of the media file in audio format for each sentence; and a metadata module configured to store the sentence position indicator from the text file and the associated timestamp from the audio file in a database.

In another exemplary embodiment, the PLAYPLAT may include a processor-implemented method of presenting a user interface on a user device. The method may include receiving input from at least one sensor communicating with the user device; determining a set of features to present to the user based at least on the input received from the at least one sensor, the input including device surroundings and interaction history of the user with the device; and presenting the user interface on the user device with the determined set of features.

In another exemplary embodiment, the PLAYPLAT may include a processor-implemented method of anonymous account creation and management. The method may include creating an anonymous user account on a server in response to a user launching an application on a user device, wherein the anonymous user account is identified by an anonymous indicator and the anonymous user account is established automatically without receiving a request for account creation from the user; receiving a request for account creation from the user containing at least one piece of user-identifiable information; and associating the user-identifiable information with the anonymous user account such that any content associated with the anonymous account is associated with the user-identifiable information.

### BRIEF DESCRIPTION OF THE DRAWINGS

The accompanying drawings illustrate various non-limiting, example, innovative aspects in accordance with the present descriptions:

FIG. 1 shows an example logic and data flow for a multi-format, multi-mode content delivery system, in one implementation of the PLAYPLAT operation.

FIG. 2 shows an exemplary datagram for a multi-device, multiple media-type synchronization system, in one implementation of the PLAYPLAT operation.

FIG. 3 shows an example user interaction processing module logic flow, in one implementation of the PLAYPLAT operation.

FIG. 4 shows an example content differential processing module logic flow, in one implementation of the PLAYPLAT operation.

FIG. 5 shows an exemplary user interface demonstrating asynchronous content synchronization, in one implementation of the PLAYPLAT operation.

FIG. 6 shows an exemplary user interface demonstrating asynchronous partial media synchronization, in one implementation of the PLAYPLAT operation.

FIG. 7 is an example data model for a media indexing, synchronization and transaction system, in one implementation of the PLAYPLAT operation.

FIG. 8 is an example metadata matching and storage system components block diagram, in one implementation of the PLAYPLAT operation.

FIG. 9 is an example logic flow depicting various embodiments of a media matching indexing routine, in one implementation of the PLAYPLAT operation.

FIG. 10 is an example logic flow depicting various embodiments of a media matching retrieval system, in one implementation of the PLAYPLAT operation.

FIG. 11 is an example logic flow depicting various alternative embodiments of a media matching retrieval system, in one implementation of the PLAYPLAT operation.

FIG. 12 is an example user interface depicting various embodiments of a variable user interface system based on surroundings, history, or a safety profile, in one implementation of the PLAYPLAT operation.

FIG. 13 is a block diagram illustrating an example transaction/commerce, user account and application communication system, in one implementation of the PLAYPLAT operation.

FIG. 14 is an example logic flow illustrating an embodiment of an anonymous account management system, in one implementation of the PLAYPLAT operation.

FIG. 15 shows a block diagram illustrating example aspects of a PLAYPLAT controller, in one implementation of the PLAYPLAT operation.

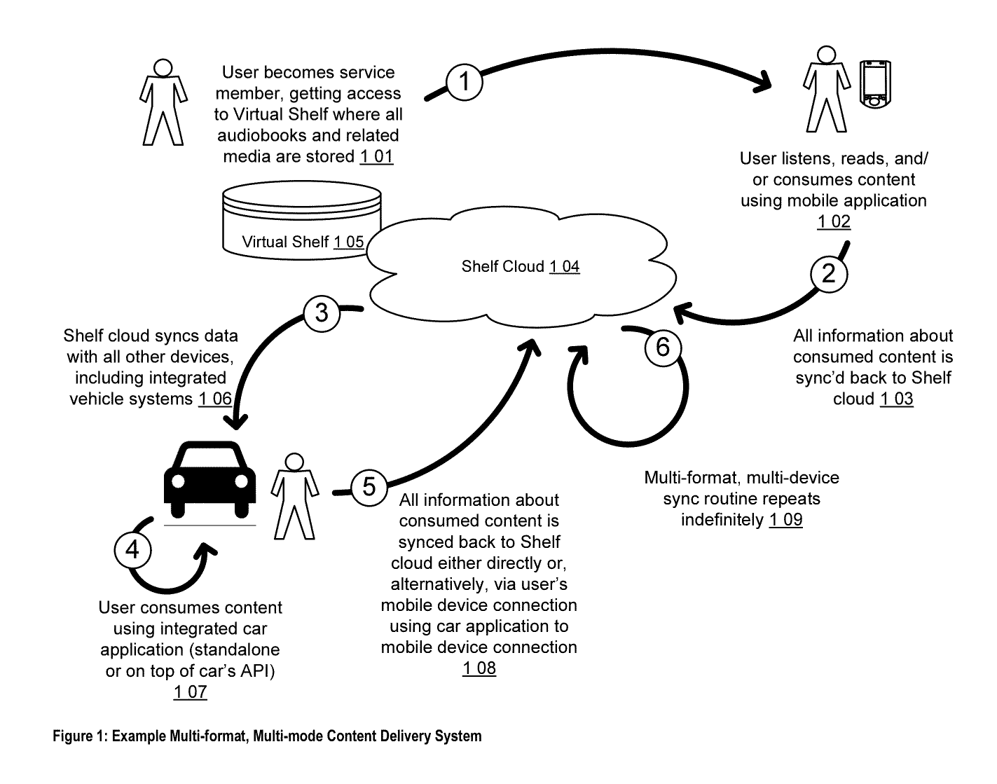

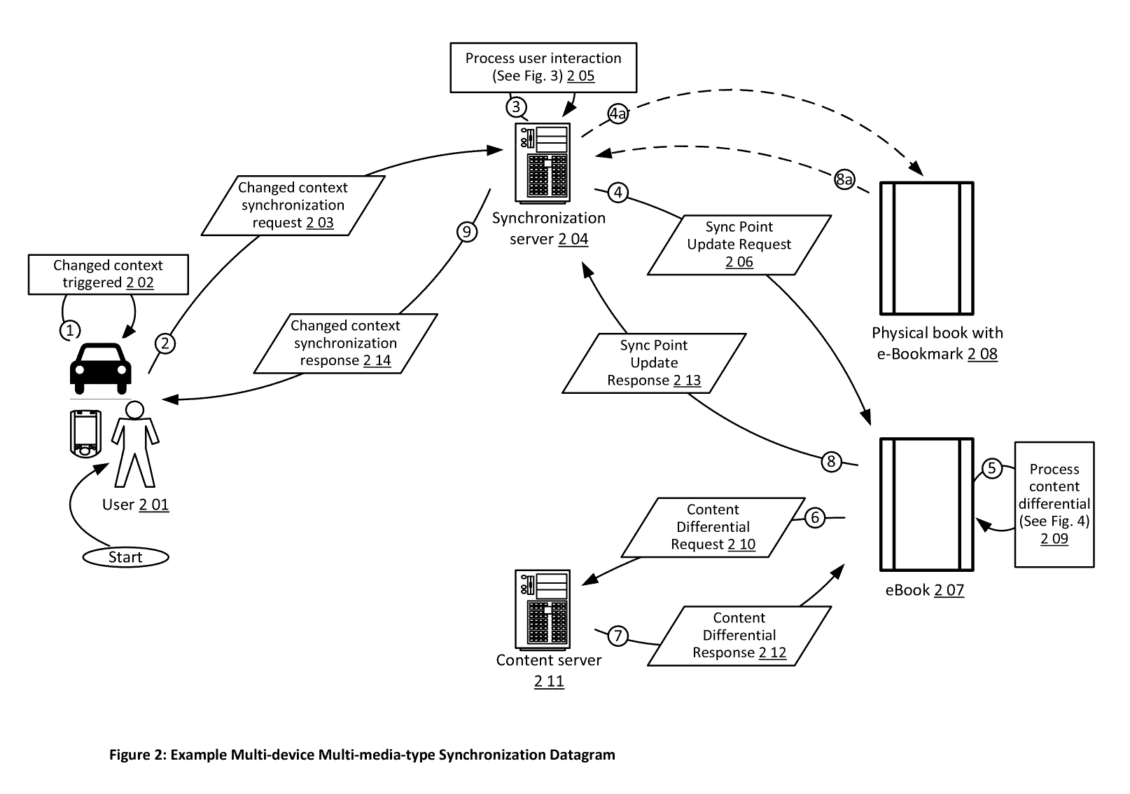

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

In one embodiment, the PLAYPLAT may be configured to facilitate seamless transitions between media in different formats. For example, media in eBook format may be configured by the PLAYPLAT to facilitate transition to an audio format. In one embodiment, the PLAYPLAT may sequentially extract sentences from an eBook. For each sentence, the PLAYPLAT may create an audio representation of the sentence suitable for use in an audio search of a file in audio format. For example, the audio representation may be generated using a speech-to-text converter, using an online search engine, and/or the like. The PLAYPLAT may then use the audio representation as a search parameter to an audio search of a file in audio format. By doing so, the PLAYPLAT may be used to discover the start point and end point of a given sentence, in audio format, within an audio file. This capability may allow the PLAYPLAT to create discrete points of synchronization between files of different formats, such as between audio and written/eBook formats. In other embodiments, the PLAYPLAT may be configured to enable reverse matching, whereby an audio file is broken into spoken sentences, converted into textual representations, and then matched with an eBook file. In still other embodiments, the PLAYPLAT may enable matching between different formats of media including but not limited to physical books, recorded audio, video, live performances, eBooks, PDFs, and/or the like. In other embodiments, the PLAYPLAT may enable matching between any storage, representation, transmission of content, and/or the like.

In another embodiment, the PLAYPLAT may be configured to enable seamless transitions between media on different devices. For example, the PLAYPLAT may be configured with a user's car audio system. The user may play audio files through the car's audio system. In one embodiment, upon leaving the car, the PLAYPLAT creates a synchronization package that represents the portion of the audio content that the user has consumed. That synchronization package may be transmitted, through wired hookup, the cloud, Near Field Communication (NFC), WiFi, and/or the like to a user's mobile device. The synchronization package may also be stored either prior to or after transmission in order to accommodate service disruptions that may occur in various transmission methods, such as wireless. In doing so, the PLAYPLAT can enable asynchronous transmission of synchronization packages. In one embodiment, the synchronization package may indicate the audio portions that the user has previously consumed. In other embodiments, the synchronization package may indicate audio portions that the user has not yet consumed. The synchronization package may also indicate the portions of media consumed in multiple formats, such as audio and eBook. In doing so, the PLAYPLAT may allow a user to transition not only between devices but also between formats. For example, a user may desire to consume media content in audio format when in a car but prefer to consume media content in written format when at home. The PLAYPLAT may also allow the user to continue consumption of media in the same or a different format from the place the user last left off in their consumption. Through cross-device and cross-format synchronization, the PLAYPLAT may be configured to allow these and similar seamless transitions. In another embodiment, the user device may download only the non-consumed portion of a media file, thereby saving bandwidth, reducing usage fees, and allowing faster device and format changes for the user.

In still other embodiments, the PLAYPLAT may restrict the way in which a user may consume content depending upon external factors. For example, if a user's car is in motion, the PLAYPLAT may only allow the user to consume media in audio format and may present a restricted list of controls to the user such as “Nay” and “Pause.” When the user's car is not in motion, other options may be available for media control and consumption.

In some embodiments, the PLAYPLAT may be configured to allow account creation without initial user registration. In doing so, users may be able to interact anonymously with an application or interface. In one embodiment, upon an initial interaction, the PLAYPLAT may create an anonymous account using an identifier that does not disclose any user identifiable information. Using the anonymous account identifier, the user may be granted access to content or application features. At some future point, the user may then desire to create a non-anonymous account using the PLAYPLAT. For example, the user may provide an identifying piece of information, such as a name, email address and/or similar information to the PLAYPLAT. The identifiable information is then matched to an anonymous account identifier and the anonymous account is converted to a non-anonymous account. In doing so, users may interact using the PLAYPLAT before disclosing any identifiable information. Upon conversion of an anonymous account to a non-anonymous account, the user's account history will be preserved.

In some embodiments, the PLAYPLAT may be configured to allow the user to engage in commerce. For example, the user may be presented with purchase options based on the user's previous location information (such as GPS information). The user may also be presented with options for media purchase based on previous media consumption. For example, the user may be prompted to purchase a sequel to an audio book as the user's consumption nears the end of an audio book. In doing so, the PLAYPLAT may enable seamless transitions not only between media devices and media formats, but also between different media.

FIG. 1 shows an example multi-format, multi-mode content delivery system. In some embodiments, a user may enroll in a service where they will be given access to a Virtual Shelf 105. The Virtual Shelf may store media that the user has purchased or otherwise has access to (e.g., media that the user has purchased previous to enrollment in the service.) 101. The Virtual Shelf may be located on one or more of the user's devices, in ephemeral storage, in a cloud such as Shelf Cloud 104, and/or the like. By allowing content and the shelf to exist in or be accessed from multiple locations, the user may be permitted to access content from multiple locations and have their usage tracked and content consumption synchronized between the devices and/or locations.

After gaining access to the user's Virtual Shelf 105, the user may consume content on multiple devices, such as via a mobile application 102. Consuming content is generally any action which allows a user to read, listen to, and/or otherwise experience in some manner content stored on the user's Virtual Shelf 105 and/or in the Shelf Cloud 104. By virtue of consuming content, certain usage information is generated and may be stored on a user's device and/or in the Virtual Shelf or Shelf Cloud. Usage information may include the amount of content consumed, the starting point of consumption, the ending point of consumption, the device on which consumption occurred, the speed of consumption over time (which may be expressed as a rate such as pages/minute), the location of the user during consumption (by using a device's built in GPS, via a connection to the user's cell phone GPS, tower triangulation, estimation based on previous location points, and/or the like). All of the content consumption and usage information is then sync'd, e.g., 103, from the user's device to the Shelf Cloud 104 and/or Virtual Shelf 105.

In some embodiments, upon receiving a transmission of consumed content, the Shelf Cloud 104 and/or Virtual Shelf 105 may initiate a synchronization of some or all of the usage data to other devices the user may have access to 106. Such devices may be devices owned by the user or devices that are otherwise public but on which the user may also have access to in some manner (e.g., password login, encryption key login, and/or the like). In doing so the PLAYPLAT may enable a user access to their content on a larger set of devices and/or interfaces. Upon receipt of a synchronization, in some embodiments, the user device receiving the transmission may initiate an action to progress a pointer to the most recent portion of content that the user consumed on another device. In doing so, the PLAYPLAT may allow a user to seamlessly transition from one media device to another.

In some embodiments, content on one of the devices receiving a synchronization may be in a different form from the previously consumed content. For example, the user may have consumed content from an electronic book on their mobile device (e.g., e-Reader and/or the like). The content on that device may be indexed, for instance, by sentence or paragraph. In transitioning to another device, such as an automobile, the user may also transition to another form of the same content, such as an audio recording of the same content, an electronic voice rendering of the eBook, and/or the like. The Virtual Shelf may, in some embodiments, contain or be in communication with a capability of synchronizing between different media types. For example, page 7 at paragraph 5 of an eBook may be corresponded to an audio form of the content at the 2 minute 51 second mark in an audio file. In facilitating this transition, the PLAYPLAT may allow a user to seamlessly transition not only between devices but also between media types.

In some embodiments, the user may then continue consuming content in another context, such as a car application 107. The car application may be one which is integrated into the user's car operating system, embedded system, and/or the like. In other embodiments, the car system may be built on top of an Application Programming Interface (“API”), such as one provided by the car manufacturer. Illustrative examples of APIs for car systems include the BMW™ iOS application and API with integration into the BMW™ car line, Entune by Toyota, Ford Sync by Ford, and/or the like. Other APIs and integration methods may be available.

In some embodiments, the user's usage information may then be synchronized from the car application back to the Shelf Cloud 104 and/or the Virtual Shelf 105, e.g., 108. The shelf cloud may then re-synchronize with all of the devices available to the user. The synchronization/consumption loop may continue indefinitely, e.g., 109, enabling a user to continue to consume content in multiple formats across multiple devices.

FIG. 2 is an example datagram depicting a multi-device, multiple media-type synchronization system. In one embodiment, a user 201 may consume content within their automobile. Upon reaching their destination, the user may then end consumption of the media by, in one embodiment, turning the car off and exiting the vehicle. Alternatively, the user may end consumption of media by signaling to their car audio system to stop playing content. In some embodiments, the stopping of content consumption may cause the vehicle integrated operating system and/or an application running within the vehicle, or trigger a changed context procedure 202. The change context procedure may, in some embodiments, signal to a synchronization server 204 that the user has finished consuming content, exited the vehicle, transitioned to another device such as a mobile device, and/or the like.

In some implementations, the application and/or user may generate a changed context synchronization request, e.g., 203, and provide the changed context synchronization request to the synchronization server, e.g., 204. For example, the application may provide a (Secure) Hypertext Transfer Protocol (“HTTP(S)”) POST message including data formatted according to the eXtensible Markup Language (“XML”). Below is an example HTTP(S) POST message including an XML-formatted changed context synchronization request, e.g., 203, in one implementation:

```
POST /changed_context.php HTTP/1.1
Host: www.syncserver.com
Content-Type: Application/XML
Content-Length: 718
<?XML version = “1.0” encoding = “UTF-8”?>
<changed_context_synchronization_request>
    <user_id>485415</user_id>
    <timestamp>2020-02-22 15:22:43</timestamp>
    <user_email>john.q.public@fakeemail.com</user_email>
    <device_starting id=2>Car audio system</device_starting>
    <device_next id=4>Mobile Phone</device_next>
    <device_also_sync id=7>eBook Reader</device_also_sync>
    <media_consumed>
        <media>
            <media_id>1234</media_id>
            <title>Great Gatsby</title>
            <begin>4:52</begin>
            <end>15:02</end>
            <interactions>
                <int type=″touched screen″ time=″5:20″
location_lat=″25.2154″ location_lon=″14.2145″>
                <int type=″swipe″ time=″5:21″>
                <int type=″started_playback″ time=″4:52″>
                <int type=″paused_playback″ time=″5:05″>
                <int type=″forward″ time=″5:06″ length=″0:30″>
            </interactions>
        </media>
        <media>
            ...
        </media>
    <media_consumed>
</changed_context_synchronization_request>
```

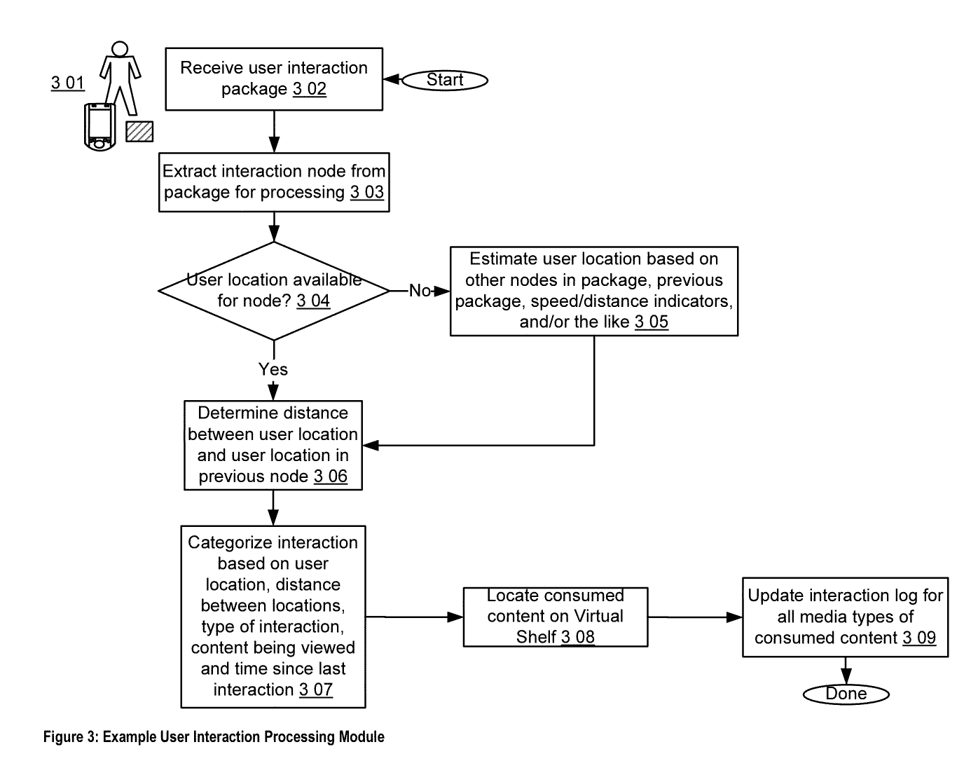

In some embodiments, the user interaction designations that indicate the user's interaction with the media may be extracted from the changed context synchronization request 203 by a User Interaction Processing Module, e.g., 205, as described in detail below in one implementation with reference to FIG. 3.

The synchronization server 204 may then retrieve a list of devices that are registered to the user and/or to which the user may otherwise have access. Such devices may be stored in a database on or in communication with the synchronization server. In response to the changed context synchronization request, the synchronization server may generate a sync point update request, e.g., 206. The sync point update request may be sent to devices on which the user may consume content. In some embodiments, the changed context synchronization request may indicate the device to which the user will consume content on next, which may be automatically calculated based on past user consumption habits (e.g., a preferred device setting, where the user usually consumes audio, and/or the like) and/or manually selected by the user. In some implementations, the application and/or user may generate a sync point update request, e.g., 206, and provide the request to a device such as an eBook, e.g., 207. Alternatively, the synchronization server may provide the sync point update request to a physical book by way of an electronic bookmark capable of receiving an update 208, an integrated car audio system, and/or the like. For example, in one implementation, a PLAYPLAT application may be embedded in a car cockpit and/or provided via one or more car software interfaces. Transmission to a car audio system may be accomplished either directly, such as through an internet connection built into the car, and/or through a connection provided by a user's mobile device (such as a mobile phone) that is also in communication with the car audio system. Other devices may also communicate with the PLAYPLAT via a connection through another device. In doing so, even devices that do not have regular PLAYPLAT connections may still function as described. For example, the application may provide a (Secure) Hypertext Transfer Protocol (“HTTP(S)”) POST message including data formatted according to the eXtensible Markup Language (“XML”). Below is an example HTTP(S) POST message including an XML-formatted sync point update request, e.g., 206, in one implementation:

```
POST /sync_point_update_request.php HTTP/1.1
Host: www.userdevice123.com
Content-Type: Application/XML
Content-Length: 718
<?XML version = “1.0” encoding = “UTF-8”?>
<sync_point_update_request>
    <user_id>485415</user_id>
    <timestamp>2020-02-22 15:22:43</timestamp>
    <user_email>john.q.public@fakeemail.com</user_email>
    <last_consumed_content>
        <type>audio</type>
        <device_id>123548</device_id>
        <consumption_end_point>15:02</consumption_end_point>
        <synchronization_id>5468412484</synchronization_id>
    </last_consumed_content>
</sync_point_update_request>
```

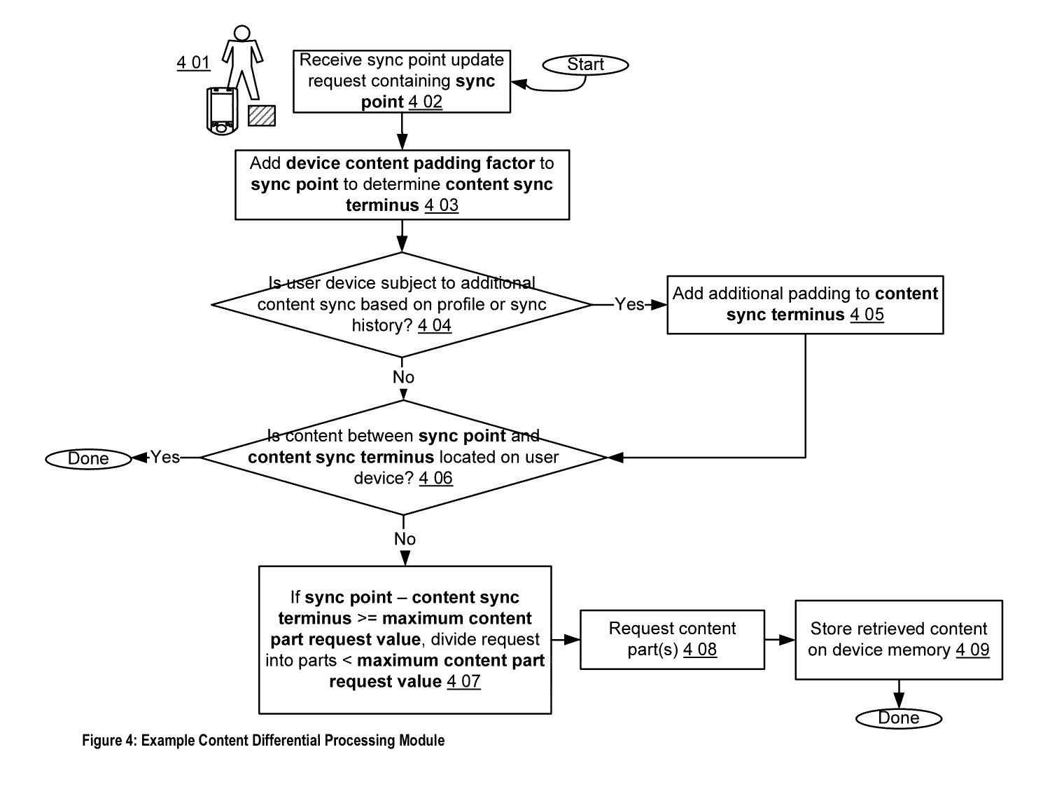

In some embodiments, the user device, e.g. 207, 208, may perform a content differential request procedure, e.g. 209, such as in response to the receipt of a sync point update request. An example content differential procedure is described below with respect to FIG. 4. A content differential request allows the user device to request from the content server 211 a subset of the total content, such as only such content as the user device requires to allow the user to continue with their content consumption. In one embodiment, a user transitioning between an eReader and an audio application on their mobile device may request only a partial audio file representing the portion of the audio that has not yet been consumed by the user, e.g., 210. The content server 211 may then generate a new media file on-the-fly containing only the data required by the user device, such as the remaining audio, the remaining portion of an eBook, and/or the like. In doing so bandwidth requirements may be minimized by the device. In some embodiments, a partial audio file may be generated using an application program substantially similar to the Open Source ffmpeg software package. An example command suitable for use with ffmpeg for creating an on-the-fly version of an audio file is as follows, in one implementation:
ffmpeg −ss 00:00:30.00 −t 25 −i originalmedia.mp3 −ab 256 newmedia.mp3

In some embodiments, the content server may then reply to the user device with a content differential response 212. The response may contain the complete media requested, the differential, the portion requested, a message containing instructions about how the missing portion may be downloaded from another content server, and/or the like. In doing so, the user device, e.g., 207, may receive missing content quickly while also conserving bandwidth.

The user device 207 may then reply to the synchronization server 204 with a sync point update response 213 containing information about the content that was successfully transferred. In alternative embodiments, the sync point update response 213 may contain a schedule on which the media will be downloaded at some future point by the device from a content server. In doing so, the PLAYPLAT may be configured to enable rapid synchronization responses to the synchronization server while allowing content to download to the user device 207 in an asynchronous manner. In some examples, this transfer may be scheduled for periods of less network traffic, at a time when transfer costs are decreased for the user, at a time when transfer capacity is available, and/or the like. In some embodiments, the synchronization server 204 may then, in response to the sync point update response 213, create a changed context synchronization response 214 and transmit same to the user device that initiated the changed context request 203.

In some embodiments, the synchronization server 204 and content server 211 may be combined. Additionally, the content server may load content onto a user's device, e.g., 207, that the user has not yet purchased or which is not otherwise loaded in response to a request from the device for content. In doing so, the content server 211 may indicate that the content loaded on the user device 207 may be shared and/or transmitted to other devices that require said content. This feature of the PLAYPLAT may enable any user device within the system to act as a content server, as described herein, to any other device in the system including devices not controlled by the user.

FIG. 3 is an example user interaction processing module. In some embodiments, the module may receive a user interaction package 302. The package may be contained within a larger package, such as a changed context synchronization request 203 and/or the like. In other embodiments, the user interaction package 302 may be received directly. The user interaction processing module may then extract the interactions contained within the package, 303. In some embodiments, the user interaction package may contain multiple interaction nodes, representing a single action the user performed and/or an action that was logged. For each node of interaction, a location of the user while performing that interaction (e.g., GPS, zip code, city, state, latitude/longitude, and/or the like) may be extracted if available, e.g. 304. If a user location is not available or associated with the interaction node, then an estimate of the user's location may be calculated. For example, if node #7 was at point A and node #9 was at point B, then node #8 could in some embodiments be estimated to be located at a midpoint between point A and point B, such as by linear interpolation. The distance covered and the velocity of the user between other interaction nodes may also be used to estimate the location of the interaction.

In some embodiments, the distance between the last processed node and the current node being processed may be calculated 306. The interaction node may contain information such as the type of interaction. Example types of interactions may include but are not limited to: a swipe of a card, a tap on a touch-screen device, turning an eBook page, turning a physical page, taking a photo using an integrated device camera, turning a physical nob, and/or the like. In some embodiments, the interaction node may be categorized based on the user location, distance between locations 306, type of interaction, and/or the content that was being viewed at the time of the interaction 307. In doing so, a robust picture of the user's interaction with the media may be formed, such as for use in targeting offers and opportunities to a user. In some embodiments, the user interaction processing module may locate the content associated with the interaction nodes on a user's Virtual Shelf, e.g., 308. All of the media types for this content (e.g., audio book version, eBook, etc.) may then be updated to be associated with the user interaction nodes and/or the user interaction package, e.g., 309.

FIG. 4 is an example content differential processing module. In some embodiments, a sync point update request is received 402. The update request may contain a sync point which represents the last portion of the media consumed by the user 401. In order to calculate how much media should be downloaded to a user device, a device-specific content padding factor may be added to the sync point to determine a content sync terminus, e.g., 403. In doing so, in some embodiments, the amount of content that is downloaded to a given device or device type may be varied, such as to minimize costs, conserve bandwidth, and/or the like.

In some embodiments, the user device may be subject to additional content sync constraints 404. For example, a device that is only infrequently within range of an Internet access point (e.g., WiFi, cellular, and/or the like) may be designated by the PLAYPLAT or optionally directly by the user or a network owner (e.g., ISP) as being subject to additional content sync constraints. If the user device is subject to additional content sync constraints, additional padding may be added to the content sync terminus 405.

In some embodiments, the user device will then determine if the content within the sync point and the content sync terminus already exists within the memory of the user device 406. In other embodiments, this information may be tracked by the PLAYPLAT directly and therefore the user device may be unaware of which content it contains. This capability enhances the security of content contained on the device and may protect the device against unauthorized access and/or hacking. If the content between the sync point and the content sync terminus already exists on the user device, the procedure may exit.

Alternatively, if the content between the sync point and the content sync terminus is not located on the user device, the content may be requested for download. In some embodiments, the user device may be limited in how much content it can request 407. For example, if the difference between the sync point and the content sync terminus is greater than a maximum content part request value, the content request may be divided into parts such that each part is no larger than the maximum content part request value. The maximum content part request value may be set by the user, by the PLAYPLAT administrator, by the user device manufacturer, by a network connectivity provider such as an ISP, and/or the like. In some embodiments the content may then be requested either wholly or in parts as described herein 408. The user device may then store the content within its memory, on persistent storage, and/or the like 409.

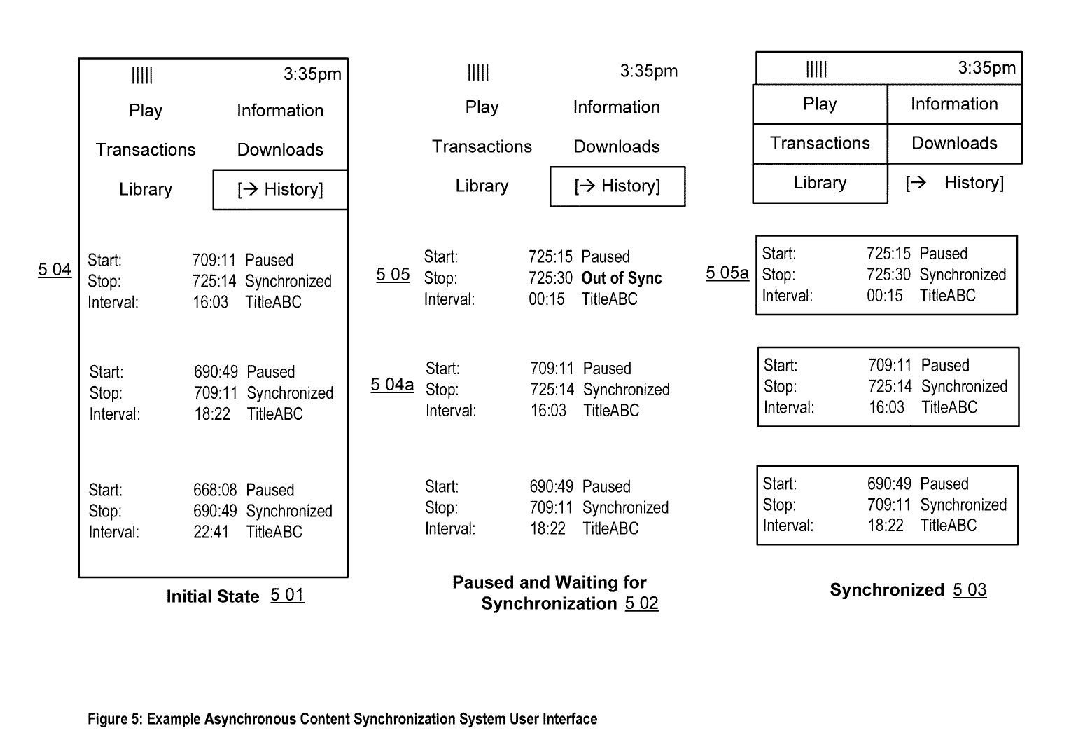

FIG. 5 is an example user interface demonstrating an asynchronous content synchronization feature of the PLAYPLAT. In some embodiments, users may desire to consume content while out of range of network connectivity (e.g., not within range of synchronization server 204). Alternatively, users may desire to minimize network and/or cellular data transfer costs by optimizing when content synchronization is performed. In one embodiment, the initial state of the user interface contains multiple tabs showing features of the PLAYPLAT as well as a history of the user's interaction with media, e.g., 501. In one example, each interaction is listed separately, e.g., 504. The user may then continue interacting with the media, which may generate new entries in the interface, e.g., 505. Previous entries may be also displayed 504a. Initially, a new entry 505 has a status indicating that the interaction has not been synchronized with the PLAYPLAT and/or the other devices the user has access to 502. In so doing, the PLAYPLAT allows the user to view the synchronization data and/or interactions that are awaiting synchronization. When the user device has established communication again with the PLAYPLAT, the interaction 505 may be synchronized and its status changed to show same 505a. In doing so, the device may be returned back to a fully synchronized state, e.g., 503.

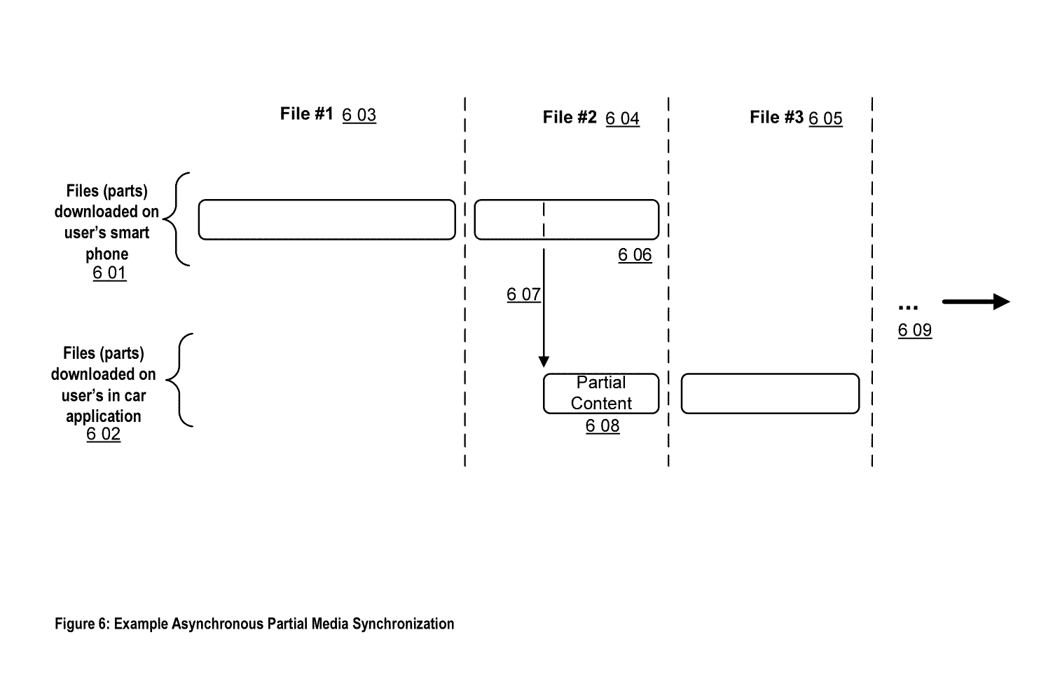

FIG. 6 is a block diagram illustrating a partial content download. In this example, a user device such as a user's smart phone has certain files and/or portions of files loaded or accessible, e.g., 601. In some embodiments, complete files may be present on the device, e.g., 603, 604. The user may consume media 606 up to a point that is less than the end of the media, e.g. 607. Thereafter, in response to a content and device synchronization procedure a portion of content less than the complete file 604 may be transferred to another user device, such as an application integrated into a user's car 602. The partial content 608 may represent the portion of the media that the user did not consume on their other device, e.g., the smart phone 601. By only transferring partial content 608, bandwidth may be reduced and/or the responsiveness of the PLAYPLAT may be enhanced. In some embodiments, the device in receipt of partial content may itself have the full file for an alternate media file, e.g. 605. Additionally, multiple full media files and/or partial media files 609 may be stored on any devices the user has access to.

In some embodiments of the PLAYPLAT, the asynchronous partial media synchronization capability may be used alone and/or in conjunction with the commerce capability of the PLAYPLAT, e.g., 1301. For example, a user that has only purchased the eBook version of a title may be automatically offered the option to purchase an audio version containing only partial content for the title, the partial content representing the portion of the media that the user has not yet consumed in the eBook version of the title. In doing so, a merchant may desire to offer a lower price to a user in this context since the resultant partial media file (containing audio for only the unconsumed portion) would be less attractive for resale since only a portion of the title was contained therein. However, from the consuming user's perspective, the partial audio file is a direct substitute for the full audio file, since the user already consumed the non-included portion of the audio file in eBook form. In facilitating such transactions, the PLAYPLAT may be configured to maximize the sale of titles in alternative media formats (such as buying an audio book version when a user already owns an eBook version of a title) without creating copies of media that may practicably be transferred to other users or third-parties.

In some embodiments of the PLAYPLAT, a user may be allowed to load content which they already own into the system for consumption on PLAYPLAT connected devices. For example, a user who owns the physical version of a book may be permitted to take a photograph of their physical book copy and their driver's license or other identifier. The PLAYPLAT may then be configured to allow the user access to an eBook version of the same title at a discounted cost. Additionally, users who can assert to the PLAYPLAT that they own a title in a certain format may procure alternate versions of the title at a discounted cost. Using PLAYPLAT components, users may demonstrate that they currently own a title in a given media format by scanning a UPC code, scanning a receipt for the item, answering challenge/response questions from the PLAYPLAT or another source sufficient to demonstrate ownership, and/or the like. Additionally, the PLAYPLAT may be configured to import a user's purchase history from a third-party web site using that site's API. An example API suitable for this purpose is the Facebook API. Alternatively, purchase history may be ascertained by the PLAYPLAT by use of a web-scraping program, such as WebWhacker, that enables the PLAYPLAT to log into a third-party web site, such as Amazon.com, as the user and download the user's purchase history. In doing so, content which has been previously purchased may be loaded into and consumed using PLAYPLAT components.

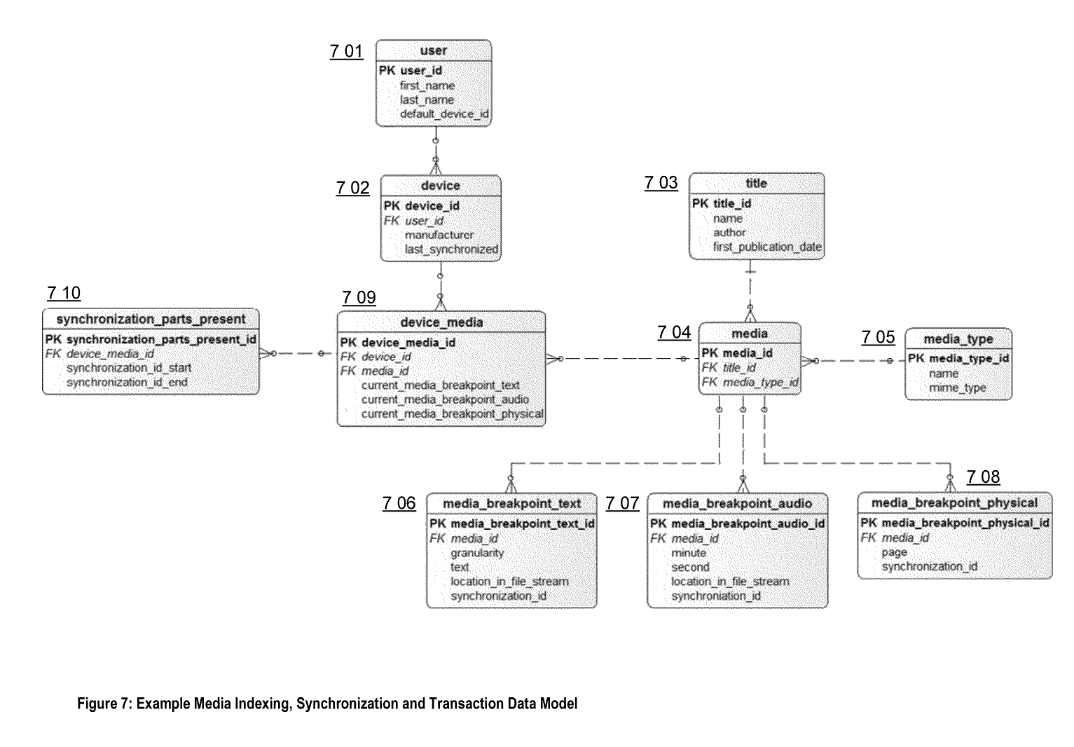

FIG. 7 is an example data model depicting portions of a media indexing, synchronization and transaction PLAYPLAT system. In some embodiments, the data model may be used to generate a database containing tables, fields and associations for use by the PLAYPLAT. Below is an example PLAYPLAT database creation sequence of commands substantially in the form of SQL statements, in one implementation:

```
CREATE TABLE \grave{ }title\grave{ } (
  \grave{ }title_id\grave{ } VARCHAR(40) NOT NULL,
  \grave{ }name\grave{ } VARCHAR(40),
  \grave{ }author\grave{ } VARCHAR(40),
  \grave{ }first_publication_date\grave{ } VARCHAR(40),
  CONSTRAINT \grave{ }PK_title\grave{ } PRIMARY KEY (\grave{ }title_d\grave{ })
) COMMENT = ‘Contains a list of the published titles. Each title represents one artistic
unit and may contain multiple media of varying types. (i.e., a single title may have an
eBook version, printed book version, audio version, etc.);
CREATE TABLE \grave{ }media type\grave{ } (
  \grave{ }media_type_id\grave{ } VARCHAR(40) NOT NULL,
  \grave{ }name\grave{ } VARCHAR(40),
  \grave{ }mime_type\grave{ } VARCHAR(40),
  CONSTRAINT \grave{ }PK_media_type\grave{ } PRIMARY KEY (\grave{ }media_type_id\grave{ })
);
CREATE TABLE \grave{ }media\grave{ } (
  \grave{ }media_id\grave{ } VARCHAR(40) NOT NULL,
  \grave{ }title_id\grave{ } VARCHAR(40) NOT NULL,
  \grave{ }media_type_id\grave{ } VARCHAR(40),
  CONSTRAINT \grave{ }PK_media\grave{ } PRIMARY KEY (\grave{ }media_id\grave{ })
);
CREATE TABLE \grave{ }media_breakpoint_text\grave{ } (
  \grave{ }media_breakpoint_text_id\grave{ } VARCHAR(40) NOT NULL,
  \grave{ }media_id\grave{ } VARCHAR(40),
  \grave{ }granularity\grave{ } VARCHAR(40),
  \grave{ }text\grave{ } VARCHAR(40),
  \grave{ }location_in_file stream\grave{ } VARCHAR(40),
  \grave{ }synchronization_id\grave{ } VARCHAR(40),
  CONSTRAINT \grave{ }PK_media_breakpoint_text\grave{ } PRIMARY KEY
(\grave{ }media_breakpoint_text_id\grave{ })
);
CREATE TABLE \grave{ }media_breakpoint_audio\grave{ } (
  \grave{ }media_breakpoint_audio_id\grave{ } VARCHAR(40) NOT NULL,
  \grave{ }media_id\grave{ } VARCHAR(40),
  \grave{ }minute\grave{ } VARCHAR(40),
  \grave{ }second\grave{ } VARCHAR(40),
  \grave{ }location_in_file_stream\grave{ } VARCHAR(40),
  \grave{ }synchroniation_id\grave{ } VARCHAR(40),
  CONSTRAINT \grave{ }PK_media_breakpoint_audio\grave{ } PRIMARY KEY
(\grave{ }media_breakpoint_audio_id\grave{ })
);
CREATE TABLE \grave{ }media_breakpoint_physical\grave{ } (
  \grave{ }media_breakpoint_physical_id\grave{ } VARCHAR(40) NOT NULL,
  \grave{ }media_id\grave{ } VARCHAR(40),
  \grave{ }page\grave{ } VARCHAR(40),
  \grave{ }synchronization_id\grave{ } VARCHAR(40),
  CONSTRAINT \grave{ }PK_media_breakpoint_physical\grave{ } PRIMARY KEY
(\grave{ }media_breakpoint_physical_id\grave{ })
);
CREATE TABLE \grave{ }user\grave{ } (
  \grave{ }user_id\grave{ } VARCHAR(40) NOT NULL,
  \grave{ }first_name\grave{ } VARCHAR(40),
  \grave{ }last_name\grave{ } VARCHAR(40),
  \grave{ }default_device_id\grave{ } VARCHAR(40),
  CONSTRAINT \grave{ }PK_user\grave{ } PRIMARY KEY (\grave{ }user_id\grave{ })
);
CREATE TABLE \grave{ }device\grave{ } (
  \grave{ }device_id\grave{ } VARCHAR(40) NOT NULL,
  \grave{ }user_id\grave{ } VARCHAR(40),
  \grave{ }manufacturer\grave{ } VARCHAR(40),
  \grave{ }last_synchronized\grave{ } VARCHAR(40),
  CONSTRAINT \grave{ }PK_device\grave{ } PRIMARY KEY (\grave{ }device_id\grave{ })
);
CREATE TABLE \grave{ }device_media\grave{ } (
  \grave{ }device_media_id\grave{ } VARCHAR(40) NOT NULL,
  \grave{ }device_id\grave{ } VARCHAR(40),
  \grave{ }media_id\grave{ } VARCHAR(40),
  \grave{ }current_media_breakpoint_text\grave{ } VARCHAR(40),
  \grave{ }current_media_breakpoint_audio\grave{ } VARCHAR(40),
  \grave{ }current_media_breakpoint_physical\grave{ } VARCHAR(40),
  CONSTRAINT \grave{ }PK_device_media\grave{ } PRIMARY KEY (\grave{ }device_media_id\grave{ })
);
CREATE TABLE \grave{ }synchronization_parts_present\grave{ } (
  \grave{ }synchronization_parts_present_id\grave{ } VARCHAR(40) NOT NULL,
  \grave{ }device_media_id\grave{ } VARCHAR(40),
  \grave{ }synchronization_id_start\grave{ } VARCHAR(40),
  \grave{ }synchronization_id_end\grave{ } VARCHAR(40),
  CONSTRAINT \grave{ }PK_synchronization_parts_present\grave{ } PRIMARY KEY
(\grave{ }synchronization_parts_present_id\grave{ })
);
ALTER TABLE \grave{ }media\grave{ } ADD CONSTRAINT \grave{ }media_type_media\grave{ }
  FOREIGN KEY (\grave{ }media_type_id\grave{ }) REFERENCES \grave{ }media_type\grave{ } (\grave{ }media_type_id\grave{ });
ALTER TABLE \grave{ }media\grave{ } ADD CONSTRAINT \grave{ }title_media\grave{ }
  FOREIGN KEY (\grave{ }title_id\grave{ }) REFERENCES \grave{ }title\grave{ } (\grave{ }title_id\grave{ });
ALTER TABLE \grave{ }media_breakpoint_text\grave{ } ADD CONSTRAINT
\grave{ }media_media_breakpoint_text\grave{ }
  FOREIGN KEY (\grave{ }media_id\grave{ }) REFERENCES \grave{ }media\grave{ } (\grave{ }media_id\grave{ });
ALTER TABLE \grave{ }media_breakpoint_audio\grave{ } ADD CONSTRAINT
\grave{ }media_media_breakpoint_audio\grave{ }
  FOREIGN KEY (\grave{ }media_id\grave{ }) REFERENCES \grave{ }media\grave{ } (\grave{ }media_id\grave{ });
ALTER TABLE \grave{ }media_breakpoint_physical\grave{ } ADD CONSTRAINT
\grave{ }media_media_breakpoint_physical\grave{ }
  FOREIGN KEY (\grave{ }media_id\grave{ }) REFERENCES \grave{ }media\grave{ } (\grave{ }media_id\grave{ });
ALTER TABLE \grave{ }device_media\grave{ } ADD CONSTRAINT \grave{ }device_device_media\grave{ }
  FOREIGN KEY (\grave{ }device_id\grave{ }) REFERENCES \grave{ }device\grave{ } (\grave{ }device_id\grave{ });
ALTER TABLE \grave{ }device_media\grave{ } ADD CONSTRAINT \grave{ }media_device_media\grave{ }
  FOREIGN KEY (\grave{ }media_id\grave{ }) REFERENCES \grave{ }media\grave{ } (\grave{ }media_id\grave{ });
ALTER TABLE \grave{ }device\grave{ } ADD CONSTRAINT \grave{ }user_device\grave{ }
  FOREIGN KEY (\grave{ }user_id\grave{ }) REFERENCES \grave{ }user\grave{ } (\grave{ }user_id\grave{ });
ALTER TABLE \grave{ }synchronization_parts_present\grave{ } ADD CONSTRAINT
\grave{ }device_media_synchronization_parts_present\grave{ }
  FOREIGN KEY (\grave{ }device_media_id\grave{ }) REFERENCES \grave{ }device_media\grave{ }
(device_media_id\grave{ });
```

In some embodiments, the PLAYPLAT may be configured to store data about users of the system, e.g., 701. Personal information such as a user's name, email, and/or the like may be stored as well as a default device identifier that designates the device the user prefers to consume media on. Multiple default device identifiers may be stored to designate user preferred consumption devices for various media types. (e.g., iPhone for audio files, Kindle for eBooks, and/or the like) A user 701 may be associated with one or more devices 702. A device may have a manufacturer, serial number, a designation of the capabilities of the device (such as cellular capable, color display, and/or the like), a designator of the last time the device was synchronized, and/or the like.

In some embodiments, titles 703 may be stored by the PLAYPLAT and/or its components. Details describing the content such as name, author, initial publication date, and/or the like may also be stored. In one implementation, a title represents a unique artistic unit that is independent of the media on which it is embodied. For example, the audio, eBook, and physical book version of The Great Gatsby would all be one title. Titles may be associated with multiple media 704. A media record may represent a manifestation of the title in some form, such as an audio, eBook, and/or physical version of the title. A media record may have a type 705 that is used by the PLAYPLAT to automatically determine which devices may consume the media, such as by using a mime-type or the media.

Media 704 may, in some embodiments, be associated with one or more entries that depict breakpoints in the media. Breakpoints allow media of different types to be synchronized. For instance, a physical book's page 45 may correspond to the same title's audio version at 25 minutes and 15 seconds. Depending upon the type of media, the breakpoints may be characterized differently. For example, textual media may contain breakpoint entries 706 with the text that represents the breakpoint (such as a sentence from a book), and/or a location of the breakpoint within a file stream. Alternatively, audio media may contain breakpoints 707 associated with time in the audio file such as a minute/second marker. Physical media may contain breakpoints 708 associated with physical page numbers. A given title may have multiple media, each with multiple breakpoint entries in any/all of the various breakpoint tables. In some embodiments, the breakpoint tables may be combined. Breakpoint tables 706, 707, 708 may also contain a common index, such as a synchronization_id, that allows the same point within a title to be matched across media types. In doing so, the PLAYPLAT may seamlessly transition a user across multiple media files for the same title, while preserving information about what portions of the title the user has already consumed.

In some embodiments, devices may be associated with the media which they may contain 709. A single device may have multiple media each belonging to the same title, such as when a user's mobile device contains both the eBook and audio version of a title. In doing so, the PLAYPLAT also allows a user to transition between media on the same device in a seamless manner.

In some embodiments, only portions of a media file or a title may be present on a user device 702. The PLAYPLAT may track which portions of the media have been already loaded onto a device, such as through table 710. In doing so, the PLAYPLAT and/or user device may conserve bandwidth and/or allow a more responsive user experience for the user.

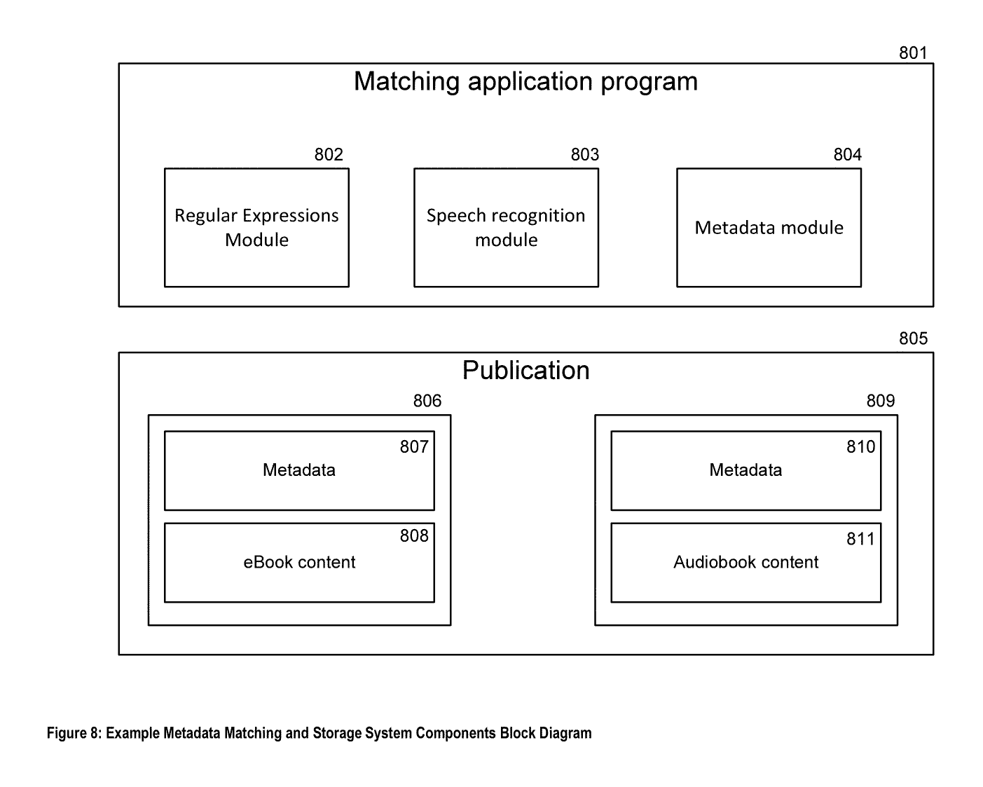

FIG. 8 is an example metadata matching and storage system components block diagram. In various embodiments of the PLAYPLAT, media loaded into or available to the system must be indexed to create universal synchronization points, e.g., synchronization_id as described above, such that media of different type (e.g., audio book, eBook, physical book) can be seamlessly transitioned between. In one embodiment, the PLAYPLAT contains a matching application program 801 that is suitable for indexing media and creating breakpoints between media of different types. For example, some media files may be indexed using a regular expression module such as 802. By using regular expressions to extract, for example, paragraphs in an eBook, indexing may be accomplished in a consistent manner. An example of a programming language suitable for regular expression processing of textual media files (or media files which may be converted to a textual representation) is PERL.

In some embodiments, the matching application program 801 may contain a speech recognition module 803 suitable for converting audio files containing spoken words to a textual representation. In doing so, media audio files may be synchronized against media of an eBook or physical book type. Example speech recognition modules suitable for use for this purpose may include CMU Sphinx, Kaldi, SHoUT, and/or the like. In still other embodiments, the matching application program 801 may contain a metadata module. This module may be used to extract metadata from a file for use in indexing. An example metadata type is EXIF and may be used to represent textual information about a file that is otherwise not textual. An example EXIF data extraction program is the ImageMagick open source library.

Once a title has been indexed by the matching application program, it may be stored in a manner that associates content that is the same title or publication together, e.g., 805. For example, a single title may have an ebook version 806 and an audiobook version 809. The eBook may contain the actual eBook content 808 as well as metadata 807 such as that generated by the matching application program 801. Additionally, an audiobook 809 may contain the actual audiobook content 811 and metadata 810 such as that generated by the matching application program 801.

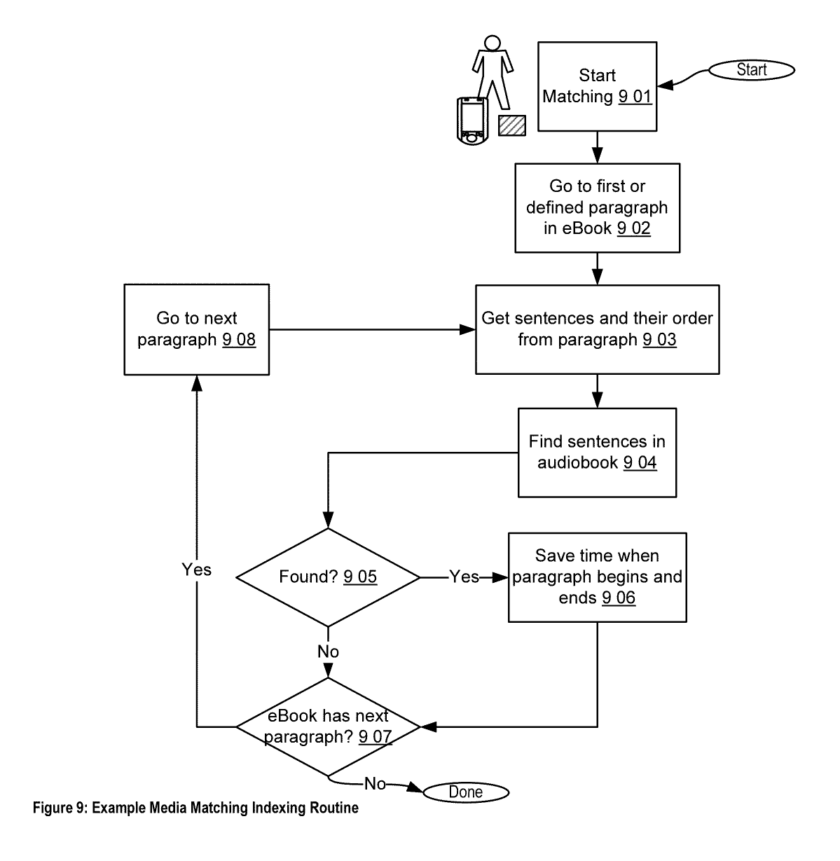

FIG. 9 is an example media matching indexing routine logic flow. In some embodiments, the matching routine may be triggered 901 by the loading of new content, titles, or media into the PLAYPLAT. The PLAYPLAT may extract the first paragraph from a media of print type, such as an eBook or physical book 902. Sentences are then extracted from the paragraph and an order of sentences is ascertained 903 to aid in matching against non-perfect data (such as against text resulting from an audio-to-text conversion, e.g., 803 speech recognition module). In doing so, the PLAYPLAT may effectuate indexing of media even where the correlation between the media (e.g., audio to print) is imperfect, such as when a sentence is missing. In some embodiments, the sentences are then found within an audiobook version of the media 904. If the sentence is found 905, a time stamp for the beginning and end of the sentence in the audio file is stored 906. If the eBook has additional paragraphs 907, the procedure repeats 908.

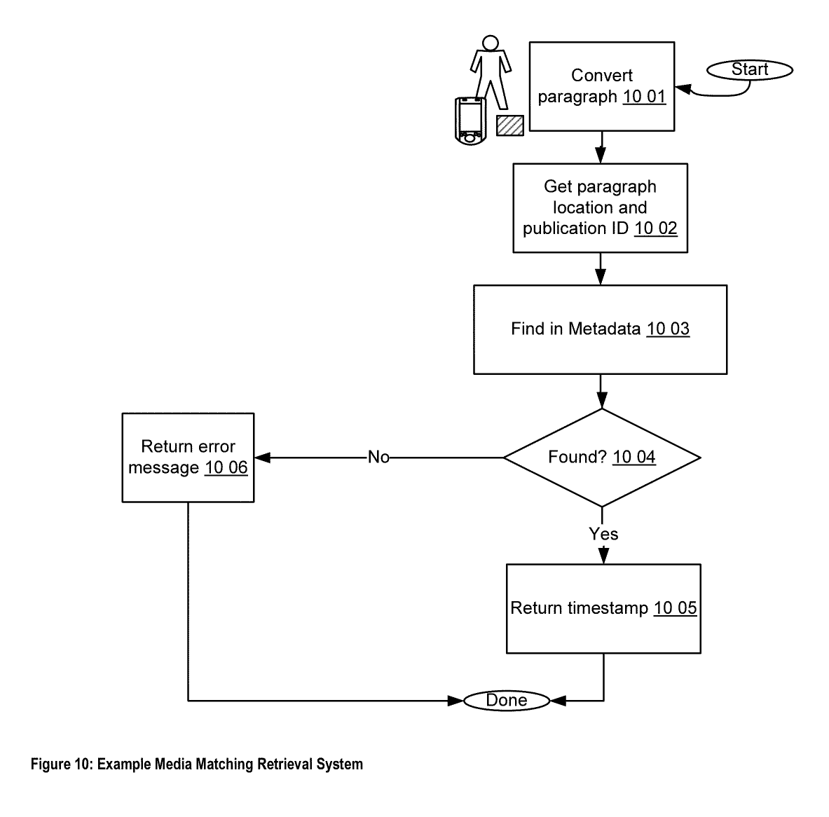

FIG. 10 is an example media matching retrieval system logic flow. In some embodiments, the matching retrieval system allows the conversion/association of a certain media point with an equivalent media point in a file of a different type (e.g., audio file to eBook associations). Initially the paragraph is extracted and converted to a parseable format 1001. The location of the paragraph within the media file as well as a paragraph identifier may be determined 1002. The paragraph location within the media file and/or the paragraph identifier may then be used to search the metadata for a file location in a file of a different format (as described with respect to FIG. 8), e.g., 1003. If the metadata is found 1004, a designation of the location of the paragraph in the alternative media is returned, such as a timestamp in an audio file 1005. If the metadata is not found, an error is returned 1006.

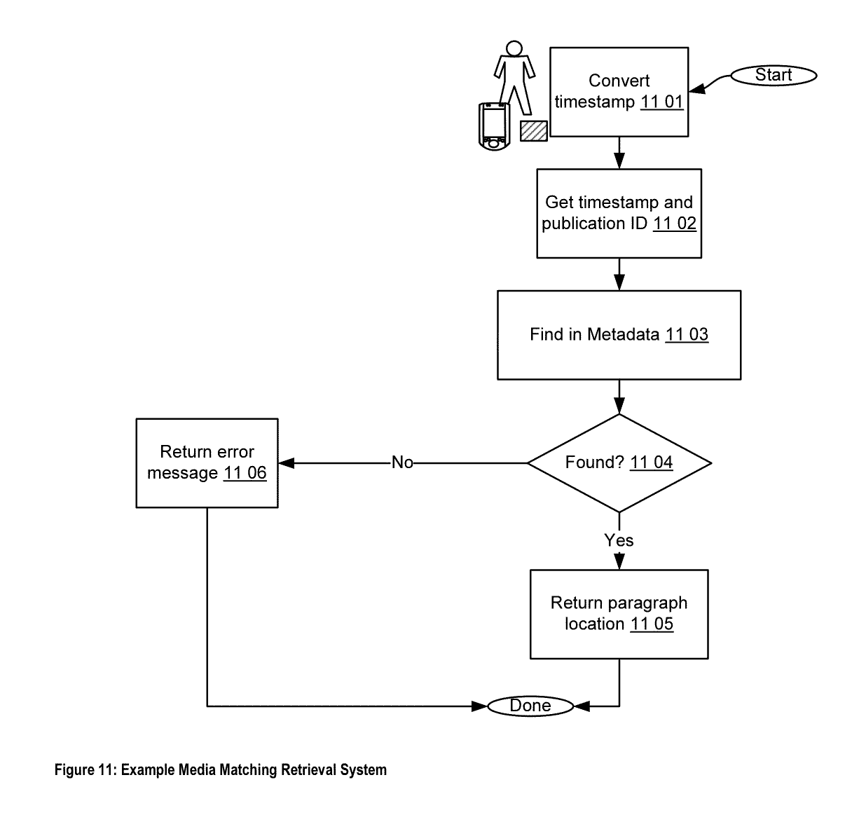

FIG. 11 is an alternative example media matching retrieval system logic flow. Initially the timestamp representing the media playback endpoint is extracted and converted to a parseable format 1101. The timestamp representing the point in an audio file as well as an identifier for the publication may be determined 1102. The timestamp location within the media file and/or the publication identifier may then be used to search the metadata for a file location in a file of a different format (as described with respect to FIG. 8), e.g., 1103. If the metadata is found 1104, a designation of the location of the timestamp in the alternative media is returned, such as a paragraph identifier in a textual file 1105. If the metadata is not found, an error is returned 1106.

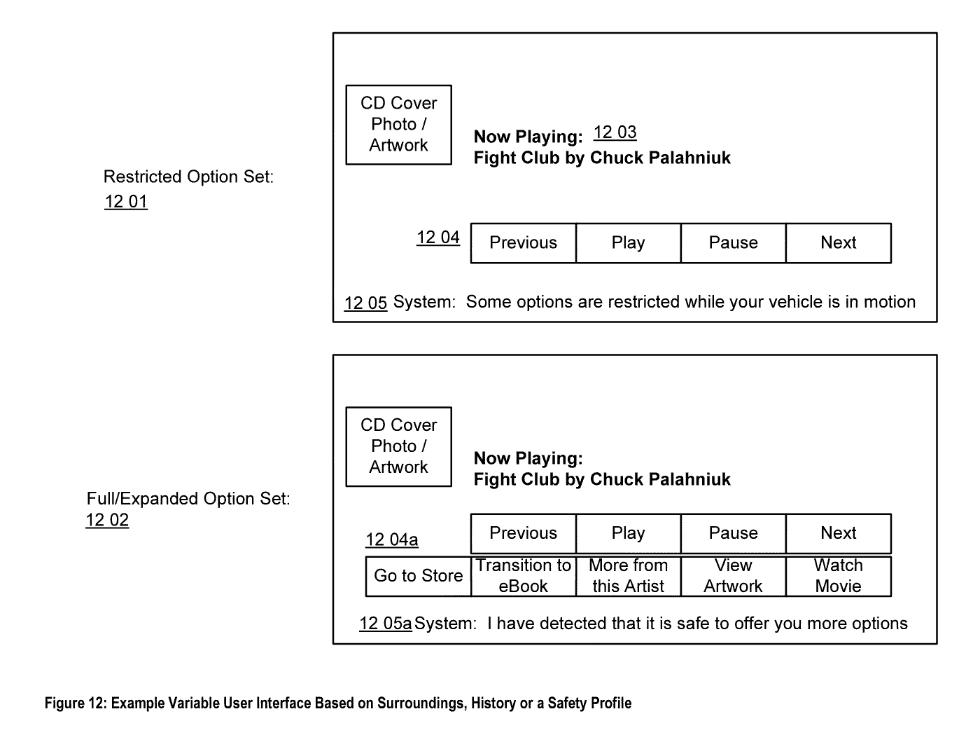

FIG. 12 is an example user interface depicting a variable user interface based on user or device surroundings, interaction history of the user with a device, and/or a safety profile. In some embodiments, a restricted option set may be offered to users consuming media via PLAYPLAT components 1201. For example, a user may be listening/consuming content 1203 while their vehicle is in motion 1205. The PLAYPLAT may therefore determine based on user settings, manufacturer settings, or laws/regulations pre-loaded or available to the device that only a limited feature set 1204 should be made available to the user in this context. In doing so, safety laws may be automatically enforced via components of the PLAYPLAT. In some embodiments, a limited feature set may be offered as a convenience to a user when the PLAYPLAT determines, based upon past usage of the device, that the user is unlikely to desire the advanced options at that point. An example of a determination is the suppressing of slow music options when a user is driving rapidly in their vehicle.

In one embodiment, the PLAYPLAT may sense (via an integration to a car computer system via an API as described above, and/or the like) that a user's car is no longer in motion 1205a and allow the user an expanded set of interaction options 1204a. In doing so, embodiments of the PLAYPLAT can offer advanced options to a user without compromising user safety.

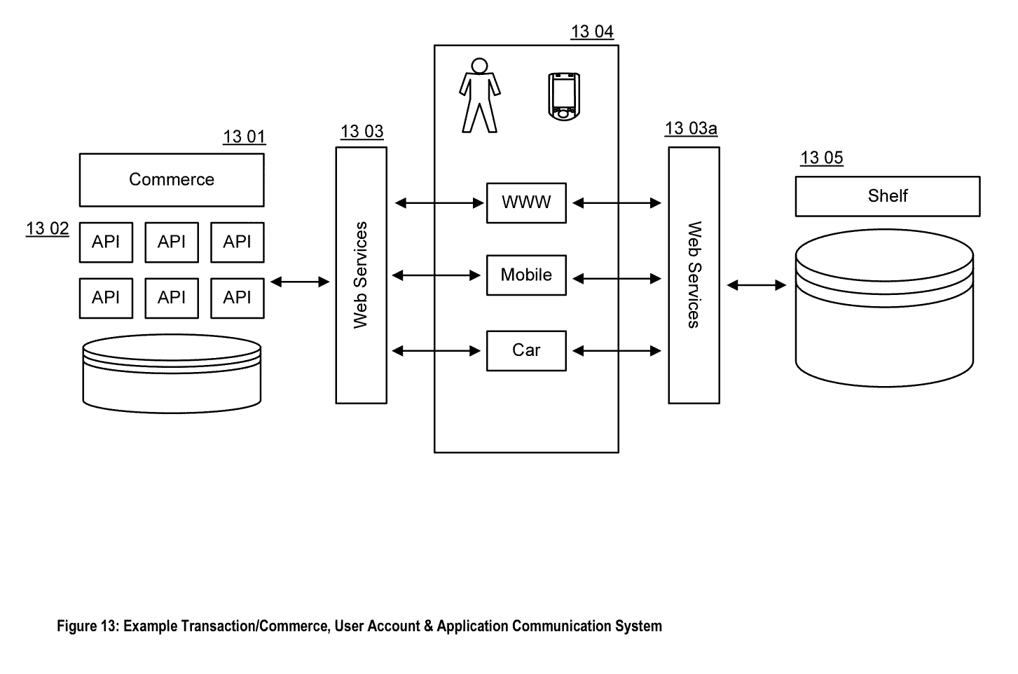

FIG. 13 is an example transaction, commerce, user account and application communication system suitable for use by the PLAYPLAT. In some embodiments, the PLAYPLAT may facilitate communication between a transaction commerce system suitable for a user to buy media 1301 and a Virtual Shelf 1305 suitable for storage of said media content. By utilizing multiple IP connected transmission methods, such as the web, a mobile device, and/or a connected car, e.g., 1304, the PLAYPLAT may utilize web services 1303 and 1303a. In engaging in a transaction with a commerce store 1301, a series of APIs 1302 may be available to the PLAYPLAT. Such APIs allow a unified mechanism for purchasing media of a certain type. By connecting the APIs and the PLAYPLAT through web services, consumption and purchase of media for use and storage on Virtual Shelf 1305 may be facilitated.

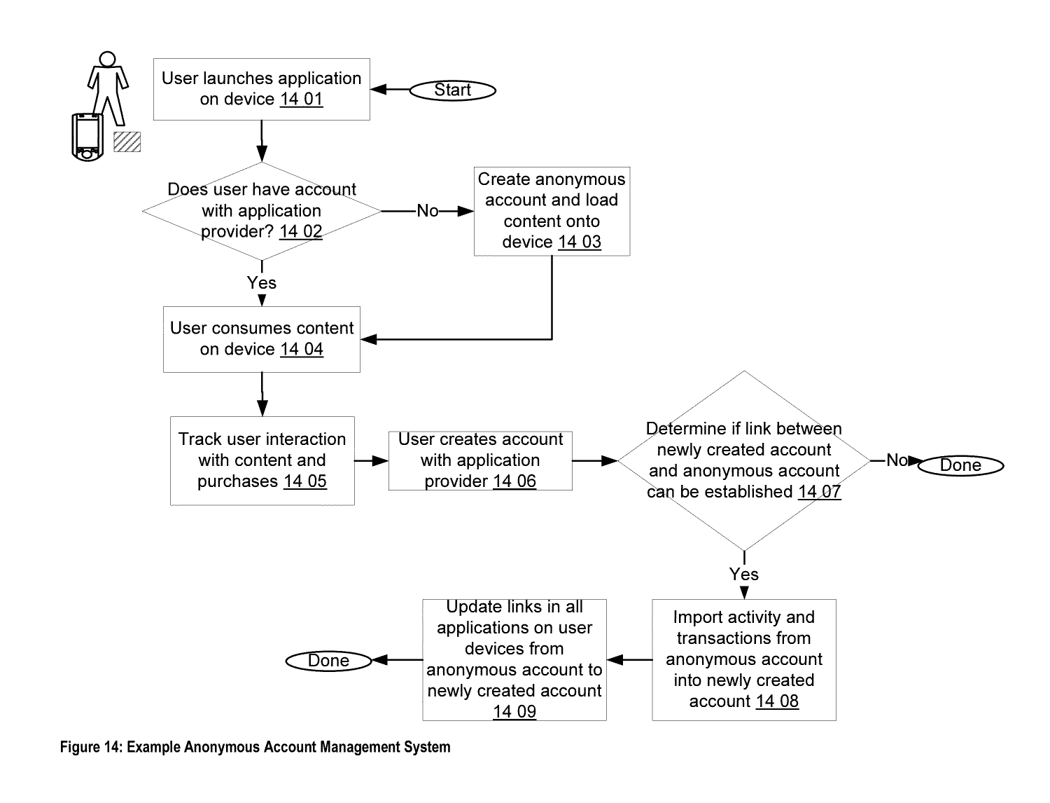

FIG. 14 is an example anonymous account creation and management service logic flow. In some embodiments, a user may wish to consume content via PLAYPLAT components without first registering for an account with a service provider. Users may desire to sample media content or to consume full versions of media before purchase. In allowing anonymous account creation and later association with created accounts, the PLAYPLAT allows for the tracking of consumer behavior using a reach back mechanism to associate anonymous interactions with a later-learned user account identity. In some embodiments, the user launches an application on a device 1401. The application determines whether the user already has an account with the application provider 1402. This may be accomplished in some embodiments through the use of account credentials on the user device, an account associated with the device at an application provider, and/or the like. If an account does not exist for the user, an anonymous account is created and content is loaded onto the user device 1403. In doing so, the user is allowed to consume content on a device 1404 even though no personally identifiable information has been provided to the application provider. In some embodiments, the PLAYPLAT then tracks the user's interaction with the content and facilitates purchases for content 1405. In some embodiments, in facilitating an anonymous purchase, an anonymous identifier may be passed to a third party application provider. That third party may then complete the transaction directly with the user and pass an indicator to the user, media content provider or other entity that indicates that the anonymous user is entitled to the purchased content. In doing so, the anonymity of users may be maintained even though purchases are made via PLAYPLAT components.

In some embodiments, an anonymous user may continue to consume content on their device. Thereafter, the user may decide to create an account with the application provider to, for example, facilitate access to their purchased media on an alternative device. The user may then provide information such as an email address, billing information, payment information, a password, a secure encryption key, and/or the like to an application provider to allow the creation of an account 1406. As a part of this data exchange, the anonymous identifier for the user may also be provided to the application provider.

The application provider may then determine, using the anonymous identifier, if any anonymous accounts exists which can be associated with the newly created user non-anonymous account 1407. If such an anonymous account exists, all activity and transactions from the anonymous account may be imported into the newly created account 1408 to facilitate cross-device, cross-media consumption as described herein. Finally, in some applications, the PLAYPLAT will determine if any links exists that point to the anonymous account, such as may exist on a user device, and update the links to now point to the newly created user account 1409.

### PLAYPLAT Controller

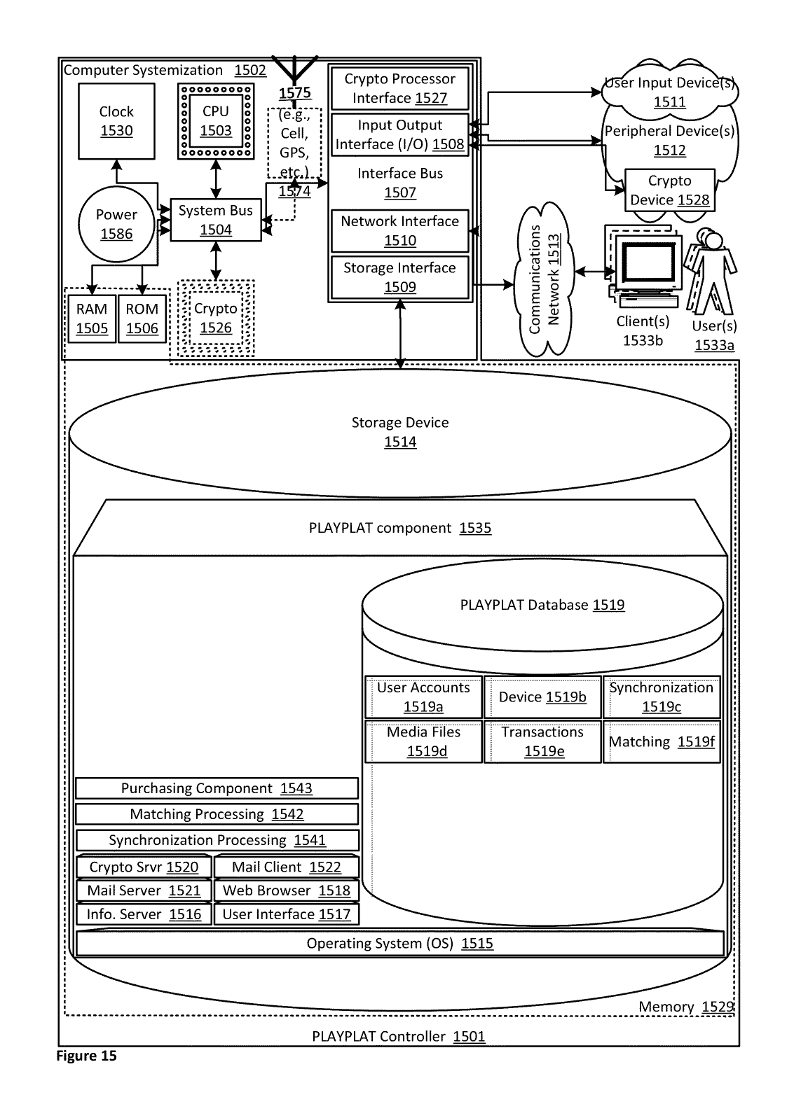

FIG. 15 shows a block diagram illustrating embodiments of a PLAYPLAT controller. In this embodiment, the PLAYPLAT controller 1501 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 1503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PLAYPLAT controller 1501 may be connected to and/or communicate with entities such as, but not limited to: one or more users from user input devices 1511; peripheral devices 1512; an optional cryptographic processor device 1528; and/or a communications network 1513.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PLAYPLAT controller 1501 may be based on computer systems that may comprise, but are not limited to, components such as: a computer systemization 1502 connected to memory 1529.

### Computer Systemization

A computer systemization 1502 may comprise a clock 1530, central processing unit (“CPU(s)” and/or “processor(s)” (these terms are used interchangeable throughout the disclosure unless noted to the contrary)) 1503, a memory 1529 (e.g., a read only memory (ROM) 1506, a random access memory (RAM) 1505, etc.), and/or an interface bus 1507, and most frequently, although not necessarily, are all interconnected and/or communicating through a system bus 1504 on one or more (mother)board(s) 1502 having conductive and/or otherwise transportive circuit pathways through which instructions (e.g., binary encoded signals) may travel to effectuate communications, operations, storage, etc. The computer systemization may be connected to a power source 1586; e.g., optionally the power source may be internal. Optionally, a cryptographic processor 1526 and/or transceivers (e.g., ICs) 1574 may be connected to the system bus. In another embodiment, the cryptographic processor and/or transceivers may be connected as either internal and/or external peripheral devices 1512 via the interface bus I/O. In turn, the transceivers may be connected to antenna(s) 1575, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing PLAYPLAT controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PLAYPLAT controller and beyond through various interfaces. Should processing requirements dictate a greater amount speed and/or capacity, distributed processors (e.g., Distributed PLAYPLAT), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PLAYPLAT may be achieved by implementing a microcontroller such as CAST's R8051XC2 microcontroller; Intel's MCS 51 (i.e., 8051 microcontroller); and/or the like. Also, to implement certain features of the PLAYPLAT, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PLAYPLAT component collection (distributed or otherwise) and/or features may be implemented via the microprocessor and/or via embedded components; e.g., via ASIC, coprocessor, DSP, FPGA, and/or the like. Alternately, some implementations of the PLAYPLAT may be implemented with embedded components that are configured and used to achieve a variety of features or signal processing.

Depending on the particular implementation, the embedded components may include software solutions, hardware solutions, and/or some combination of both hardware/software solutions. For example, PLAYPLAT features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PLAYPLAT features. A hierarchy of programmable interconnects allow logic blocks to be interconnected as needed by the PLAYPLAT system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the PLAYPLAT may be developed on regular FPGAs and then migrated into a fixed version that more resembles ASIC implementations. Alternate or coordinating implementations may migrate PLAYPLAT controller features to a final ASIC instead of or in addition to FPGAs. Depending on the implementation all of the aforementioned embedded components and microprocessors may be considered the “CPU” and/or “processor” for the PLAYPLAT.

### Power Source

The power source 1586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1586 is connected to at least one of the interconnected subsequent components of the PLAYPLAT thereby providing an electric current to all subsequent components. In one example, the power source 1586 is connected to the system bus component 1504. In an alternative embodiment, an outside power source 1586 is provided through a connection across the I/O 1508 interface. For example, a USB and/or IEEE 1394 connection carries both data and power across the connection and is therefore a suitable source of power.

### Interface Adapters

Interface bus(ses) 1507 may accept, connect, and/or communicate to a number of interface adapters, conventionally although not necessarily in the form of adapter cards, such as but not limited to: input output interfaces (I/O) 1508, storage interfaces 1509, network interfaces 1510, and/or the like. Optionally, cryptographic processor interfaces 1527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1509 may accept, communicate, and/or connect to a number of storage devices such as, but not limited to: storage devices 1514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1510 may accept, communicate, and/or connect to a communications network 1513. Through a communications network 1513, the PLAYPLAT controller is accessible through remote clients 1533b (e.g., computers with web browsers) by users 1533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PLAYPLAT), architectures may similarly be employed to pool, load balance, and/or otherwise increase the communicative bandwidth required by the PLAYPLAT controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1510 may be used to engage with various communications network types 1513. For example, multiple network interfaces may be employed to allow for the communication over broadcast, multicast, and/or unicast networks.

Input Output interfaces (I/O) 1508 may accept, communicate, and/or connect to user input devices 1511, peripheral devices 1512, cryptographic processor devices 1528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1511 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1512 may be connected and/or communicate to I/O and/or other facilities of the like such as network interfaces, storage interfaces, directly to the interface bus, system bus, the CPU, and/or the like. Peripheral devices may be external, internal and/or part of the PLAYPLAT controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the PLAYPLAT controller may be embodied as an embedded, dedicated, and/or monitor-less (i.e., headless) device, wherein access would be provided over a network interface connection.

Cryptographic units such as, but not limited to, microcontrollers, processors 1526, interfaces 1527, and/or devices 1528 may be attached, and/or communicate with the PLAYPLAT controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1529. However, memory is a fungible technology and resource, thus, any number of memory embodiments may be employed in lieu of or in concert with one another. It is to be understood that the PLAYPLAT controller and/or a computer systemization may employ various forms of memory 1529. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1529 will include ROM 1506, RAM 1505, and a storage device 1514. A storage device 1514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1529 may contain a collection of program and/or database components and/or data such as, but not limited to: operating system component(s) 1515 (operating system); information server component(s) 1516 (information server); user interface component(s) 1517 (user interface); Web browser component(s) 1518 (Web browser); database(s) 1519; mail server component(s) 1521; mail client component(s) 1522; cryptographic server component(s) 1520 (cryptographic server); the PLAYPLAT component(s) 1535; and/or the like (i.e., collectively a component collection). These components may be stored and accessed from the storage devices and/or from storage devices accessible through an interface bus. Although non-conventional program components such as those in the component collection, typically, are stored in a local storage device 1514, they may also be loaded and/or stored in memory such as: peripheral devices, RAM, remote storage facilities through a communications network, ROM, various forms of memory, and/or the like.

### Operating System

The operating system component 1515 is an executable program component facilitating the operation of the PLAYPLAT controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PLAYPLAT controller to communicate with other entities through a communications network 1513. Various communication protocols may be used by the PLAYPLAT controller as a subcarrier transport mechanism for interaction, such as, but not limited to: multicast, TCP/IP, UDP, unicast, and/or the like.

### Information Server

An information server component 1516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PLAYPLAT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PLAYPLAT database 1519, operating systems, other program components, user interfaces, Web browsers, and/or the like.

Access to the PLAYPLAT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PLAYPLAT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PLAYPLAT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the PLAYPLAT enabled nodes. The combined application may be nugatory on systems employing standard Web browsers.

### Mail Server

A mail server component 1521 is a stored program component that is executed by a CPU 1503. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the PLAYPLAT.

Access to the PLAYPLAT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1522 is a stored program component that is executed by a CPU 1503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1520 is a stored program component that is executed by a CPU 1503, cryptographic processor 1526, cryptographic processor interface 1527, cryptographic processor device 1528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PLAYPLAT may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PLAYPLAT component to engage in secure transactions if so desired. The cryptographic component facilitates the secure accessing of resources on the PLAYPLAT and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PLAYPLAT Database

The PLAYPLAT database component 1519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PLAYPLAT database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the PLAYPLAT database is implemented as a data-structure, the use of the PLAYPLAT database 1519 may be integrated into another component such as the PLAYPLAT component 1535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1519 includes several tables 1519a-f. A user accounts table 1519a includes fields such as, but not limited to: user_id, name, account_identifier, parent_account_identifier, billing—fields, password, private_key, public_key and/or the like. The user table may support and/or track multiple entity accounts on a PLAYPLAT. A device table 1519b includes fields such as, but not limited to: device ID, user ID, device_type, device_make, device_model, device_capabilities, last_synchronization_time, and/or the like. The synchronization table 1519c includes fields such as, but not limited to: sync_id, last sync_time, last_sync_id, paragraph_marker, time_marker, and/or the like. The media files table 1519d includes fields such as, but not limited to: mediafile_id, mediafile_type, matching_id, mediafile_location, user_id, transaction_id, and/or the like. The transactions table 1519e includes fields such as, but not limited to: transaction_id, transaction_date, transaction_type, user_id, mediafile_id, and/or the like. The matching table 1519f includes fields such as, but not limited to: matching_id, mediafile_id, sentence_text, sentence_id, audio_time, last_updated, and/or the like.

In one embodiment, the PLAYPLAT database may interact with other database systems. For example, employing a distributed database system, queries and data access by search PLAYPLAT component may treat the combination of the PLAYPLAT database, an integrated data security layer database as a single database entity.

In one embodiment, user programs may contain various user interface primitives, which may serve to update the PLAYPLAT. Also, various accounts may require custom database tables depending upon the environments and the types of clients the PLAYPLAT may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1519a-f. The PLAYPLAT may be configured to keep track of various settings, inputs, and parameters via database controllers.

The PLAYPLAT database may communicate to and/or with other components in a component collection, including itself, and/or facilities of the like. Most frequently, the PLAYPLAT database communicates with the PLAYPLAT component, other program components, and/or the like. The database may contain, retain, and provide information regarding other nodes and data.

### The PLAYPLATs

The PLAYPLAT component 1535 is a stored program component that is executed by a CPU. In one embodiment, the PLAYPLAT component incorporates any and/or all combinations of the aspects of the PLAYPLAT that was discussed in the previous figures. As such, the PLAYPLAT affects accessing, obtaining and the provision of information, services, transactions, and/or the like across various communications networks. The features and embodiments of the PLAYPLAT discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the PLAYPLAT's features and facilities, and in many cases reduce the costs, energy consumption/requirements, and extend the life of PLAYPLAT's underlying infrastructure; this has the added benefit of making the PLAYPLAT more reliable. Similarly, many of the features and mechanisms are designed to be easier for users to use and access, thereby broadening the audience that may enjoy/employ and exploit the feature sets of the PLAYPLAT; such ease of use also helps to increase the reliability of the PLAYPLAT. In addition, the feature sets include heightened security as noted via the Cryptographic components 1520, 1526, 1528 and throughout, making access to the features and data more reliable and secure

The PLAYPLAT may transform media file inputs, user account inputs, device inputs, and purchase inputs via PLAYPLAT components including but not limited to Synchronization Processing 1541, Matching Processing 1542 and Purchasing Component 1543 into User Accounts 1519a, Device 1519b, Synchronization 1519c, Media Files 1519d, Transactions 1519e, and Matching 1519f.

The PLAYPLAT component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PLAYPLAT server employs a cryptographic server to encrypt and decrypt communications. The PLAYPLAT component may communicate to and/or with other components in a component collection, including itself, and/or facilities of the like. Most frequently, the PLAYPLAT component communicates with the PLAYPLAT database, operating systems, other program components, and/or the like. The PLAYPLAT may contain, communicate, generate, obtain, and/or provide program component, system, user, and/or data communications, requests, and/or responses.

### Distributed PLAYPLATs

The structure and/or operation of any of the PLAYPLAT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PLAYPLAT controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value₁ is discerned as being a parameter because “http://” is part of the grammar syntax, and what follows is considered part of the post value. Similarly, with such a grammar, a variable “Value₁” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PLAYPLAT controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end
of message
do {
        $input = “”;
        $input = socket_read($client, 1024);
        $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.
jsp?topic=/com.ibm.IBMDI.doc/referenceguide295.htm

and other parser implementations:

```
  http://publib.boulder.ibm.com/infocenter/tivihelp/v2r1/index.
  jsp?topic=/com.ibm.IBMDI.doc/referenceguide259.htm
all of which are hereby expressly incorporated by reference.
```

In order to address various issues and advance the art, the entirety of this application for PLATFORM INDEPENDENT MULTIMEDIA PLAYBACK APPARATUSES, METHODS, AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a PLAYPLAT individual and/or enterprise user, database configuration and/or relational model, data type, data transmission and/or network framework, syntax structure, and/or the like, various embodiments of the PLAYPLAT, may be implemented that enable a great deal of flexibility and customization. While various embodiments and discussions of the PLAYPLAT have included herein, however, it is to be understood that the embodiments described herein may be readily configured and/or customized for a wide variety of other applications and/or implementations.

What is claimed is:

1. A processor-implemented method for synchronization of media in multiple formats across multiple devices, the method comprising:
receiving, at a synchronization server, a changed context synchronization request from a first user device configured to allow a user to consume media in a first format;
retrieving, using the synchronization server, a list of other devices accessible to a user associated with the first user device, wherein at least one of the devices is configured to allow the user to consume the media in at least a second format;
sending, using the synchronization server, a sync point update request to at least one of the devices, wherein the sync point update request includes a sync point representing the last portion of the media consumed by the user;
receiving, at the synchronization server, a sync point update response from at least one of the devices;
generating, using the synchronization server, a changed context synchronization response based on the sync point update response received from at least one of the devices; and
sending the changed context synchronization response to the first user device using the synchronization server.

2. The method of claim 1, wherein the first format is an audio file and the second format is a text-based file.

3. The method of claim 1, wherein the content synchronization request indicates the device on which the user will next consume the media.

4. The method of claim 1, further comprising:
receiving, using the synchronization server, a user interaction package from the first user device, the user interaction package including user interaction designations that indicate the user's interaction with the media; and
sending, using the synchronization server, the user interaction package to at least one of the other devices.

5. The method of claim 4, wherein the user interaction package contains a plurality of user interaction nodes, each node representing a single action performed by the user.

6. The method of claim 5, further comprising determining, for each node, the location of the user while performing the single action represented by the node.

7. The method of claim 1, further comprising:
receiving, using a content server, a content request from at least one device in response to the sync point update request;
loading the media onto the at least one device using the content server.

8. The method of claim 7, wherein the content request is a content differential request for a subset of the total content available for the media, and wherein loading the media onto the at least one device comprises loading a subset of the total content.

9. The method of claim 8, wherein the subset of the total content represents a portion of the content that has not yet been consumed by the user.

10. The method of claim 8, further comprising calculating, using the content server, a content padding factor and a content sync terminus to determine the amount of content to be loaded onto the at least one device.

11. A system for synchronization of media in multiple formats across multiple devices, the system comprising:
a server having a processor and memory;
a changed context module running on the server, the changed context module being configured to receive a changed context synchronization request from a first user device that allows a user to consume media in a first format;
a device list module running on the server and configured to retrieve a list of other devices accessible to a user associated with the first user device, wherein at least one of the devices is configured to allow the user to consume the media in at least a second format;
an update module running on the server and configured to
send a sync point update request to at least one of the devices, wherein the sync point update request includes a sync point representing the last portion of the media consumed by the user; and
receive a sync point update response from at least one of the devices;
wherein the changed context module is further configured to generate a changed context synchronization response based on the sync point update response received from at least one of the devices and to send the changed context synchronization response to the first user device.

12. The system of claim 11, wherein the first format is an audio file and the second format is a text-based file.

13. The system of claim 11, wherein the content synchronization request indicates the device on which the user will next consume the media.

14. The system of claim 11, wherein the server is configured to:
receive a user interaction package from the first user device, the user interaction package including user interaction designations that indicate the user's interaction with the media; and
send the user interaction package to at least one of the other devices.

15. The system of claim 14, wherein the user interaction package contains a plurality of user interaction nodes, each node representing a single action performed by the user.

16. The system of claim 11, wherein the server is configured to:
receive a content request from at least one device in response to the sync point update request; and
load the media onto the at least one device.

17. The system of claim 16, wherein the content request is a content differential request for a subset of the total content available for the media, and wherein the server is configured to load a subset of the total content onto the at least one device.

18. The system of claim 17, wherein the subset of the total content represents a portion of the content that has not yet been consumed by the user.

19. The system of claim 18, wherein the server is configured to calculate a content padding factor and a content sync terminus to determine the amount of content to be loaded onto the at least one device.

20. A processor-readable tangible medium for indexing and matching equivalent media files of different formats, the medium storing processor-issuable-and-generated instructions to:
receive a changed context synchronization request from a first user device configured to allow a user to consume media in a first format;
retrieve a list of other devices accessible to a user associated with the first user device, wherein at least one of the devices is configured to allow the user to consume the media in at least a second format;
send a sync point update request to at least one of the devices, wherein the sync point update request includes a sync point representing the last portion of the media consumed by the user;
receive a sync point update response from at least one of the devices;
generate a changed context synchronization response based on the sync point update response received from at least one of the devices; and
send the changed context synchronization response to the first user device using the synchronization server.
